(19) United States
(12) Patent Application Publication
(10) Pub. No.: US 2026/0353390 A1
(43) Pub. Date: Nov. 5, 2026

(54) HYBRID AUTOMATIC REPEAT REQUEST (HARQ)-ACKNOWLEDGMENT (ACK) FEEDBACK FORMATTED ACCORDING TO A FINE-TUNED CODEBOOK

(71) Applicant: QUALCOMM Incorporated, San Diego, CA (US)

(72) Inventors: June NAMGOONG, San Diego, CA (US); Wei YANG, San Diego, CA (US); Akash Sandeep DOSHI, San Diego, CA (US); Jing JIANG, San Diego, CA (US); Taesang YOO, San Diego, CA (US)

(21) Appl. No.: 19/186,121

(22) Filed: Apr. 22, 2025

(51) Int. Cl. H04W 72/1273; H04L 5/00; H04L 27/20

(52) U.S. Cl. CPC H04W 72/1273; H04L 5/0055; H04L 27/2003; H04L 27/2089

(57) ABSTRACT

Certain aspects of the present disclosure provide techniques for providing hybrid automatic repeat request (HARQ)-acknowledgement (ACK) feedback. An example method includes obtaining an indication of a plurality of codewords and a plurality of perturbation vectors that together define a codebook; obtaining a plurality of downlink control messages that schedule a plurality of downlink data messages; and sending feedback, for the plurality of downlink data messages, formatted according to the codebook.

### INTRODUCTION

### Field of the Disclosure

Aspects of the present disclosure relate to wireless communications, and more particularly, to hybrid automatic repeat request (HARQ)-acknowledgement (ACK) feedback.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining an indication of a plurality of codewords and a plurality of perturbation vectors that together define a codebook; obtaining a plurality of downlink control messages that schedule a plurality of downlink data messages; and sending feedback, for the plurality of downlink data messages, formatted according to the codebook.

Certain aspects provide a method for wireless communications by a network entity. The method includes sending an indication of a plurality of codewords and a plurality of perturbation vectors that together define a codebook; sending a plurality of downlink control messages that schedule a plurality of downlink data messages; and obtaining feedback, for the plurality of downlink data messages, formatted according to the codebook.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts example non-uniform probability distribution among codewords.

FIG. 6A depicts a process flow for communications in a network between a network entity and a UE for providing hybrid automatic repeat request (HARQ)-acknowledgement (ACK) feedback formatted according to a codebook.

FIG. 6B depicts example generation of HARQ-feedback according to a codebook defined as multiple codewords and multiple perturbation vectors.

FIG. 6C depicts other example generation of HARQ-feedback according to a codebook defined as multiple codewords and multiple perturbation vectors.

FIG. 7 depicts example perturbation vectors that are learned for different codewords in a codebook.

FIG. 8 depicts example probability distributions associated with the different codewords of the codebook referenced in FIG. 7.

FIG. 9 depicts example pruning of perturbation vectors defined for a codebook.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for providing hybrid automatic repeat request (HARQ)-acknowledgement (ACK) feedback formatted according to a fine-tuned codebook. The fine-tuned codebook may be defined as multiple codewords and multiple perturbation vectors, where each codeword of a set of the codewords (e.g., all or less than all of the codewords) in the codebook is associated with one of the perturbation vectors. Defining the codebook as the multiple codewords and the multiple perturbation vectors may allow for the exploitation of varying probabilities associated with different codewords in the codebook when generating HARQ-ACK feedback for data transmissions via different wireless communications channels and/or for different channel conditions. For example, in certain aspects, when generating and sending HARQ-ACK feedback for a data message, a carrier signal may be modulated based on a codeword in the codebook and a perturbation vector associated with the codeword.

Transmissions over wireless communications channels (e.g., such as a physical downlink shared channel (PDSCH), a physical uplink shared channel (PUSCH), etc.) are often subject to errors, at least due to non-ideal channel characteristics (e.g., such as noise, fading, interference, etc.) of such channels causing variations in signal quality. For example, a receiver may encounter an error when attempting to decode a signal that has been transmitted to the receiver over a wireless communications channel. One technique for mitigating errors in wireless communications is an automatic repeat request (ARQ), by which a receiver requests a re-transmission of a transmitted signal associated with an error. Another technique for mitigating errors in wireless communications is error correction, or channel coding, by which redundancy is systematically added to a transmitted signal through, for example, various coding schemes. The redundancy introduced by the coding scheme(s) may help a receiver of the transmitted signal to detect error(s) and, in some cases, correct them without needing to request re-transmission.

Some wireless communication technologies have adopted a combination of ARQ and error correction referred to as HARQ. Specifically, HARQ combines error correction and automatic repeat requests, allowing a receiver to request re-transmission of lost or corrupted data packets (e.g., a data packet is a formatted unit of data communicated over a network, generally including a header and a payload).

As an illustrative example, prior to transmission, a transmitter may apply an error correcting code (e.g., such as turbo codes, low-density parity-check (LDPC), etc.) to data intended for a receiver. This encoding may add redundancy (e.g., redundant bits) to the data, allowing a receiver to detect and correct errors that may occur during transmission. The encoded data may form a data packet that is transmitted over a wireless communications channel to the receiver. In some cases, the receiver may decode the received data and transmit an ACK to the transmitter confirming that the transmitted data packet was received successfully and without errors. The ACK may serve as feedback to the transmitter, indicating that the transmitter may proceed with transmitting a next data packet, as this data packet has been successfully received and decoded. In some other cases, one or more errors may occur during transmission, and the receiver may attempt to correct the error using the redundant bits (e.g., added based on the error correcting code). The receiver may transmit an ACK to the transmitter if the error is able to be corrected and the receiver is able to successfully decode the received data. Otherwise, the receiver may transmit a negative acknowledgement (NACK) (or not transmit an ACK) indicating that the transmitted data packet was not received successfully and contains errors that could not be corrected. The NACK or lack of ACK may serve as feedback to the transmitter indicating that the particular data packet needs to be re-transmitted. Upon receiving the NACK or a time after not receiving an ACK, the transmitter may re-transmit the data to the receiver. Further, in some other cases, the receiver may fail to detect and receive the data packet. As such, the data packet may be lost, and the receiver may transmit a NACK or not transmit an ACK indicating that the transmitted data packet was not received successfully. The NACK or lack of ACK may prompt the transmitter to re-transmit the data. As illustrated by this example, HARQ may help to enhance communication reliability, especially in noisy and/or unstable communication environments.

In some cases, a receiver, such as a UE, may need to provide HARQ-ACK feedback for multiple data packets at a same time (e.g., simultaneously). As used herein, the phrase “HARQ-ACK feedback” may refer to ACK feedback only, NACK feedback only, or ACK feedback and NACK feedback associated with one or more data packets. In certain aspects, HARQ-ACK feedback associated with multiple data packets (e.g., multiple ACK(s) and/or NACK(s)) may be multiplexed into a single uplink transmission (e.g., a physical uplink control channel (PUCCH) transmission) and formatted according to a HARQ-ACK codebook. Specifically, a HARQ-ACK codebook is a format for a sequence of bits to simultaneously signal multiple ACK(s) and/or NACK(s) to a transmitter, such as a network entity. A HARQ-ACK codebook may allow a receiver, such as the UE, to multiplex ACK(s) and/or NACK(s) from multiple slots, carriers, transport blocks (TBs), and/or code block groups (CBGs) within a single PUCCH or PUSCH transmission.

The Third Generation Partnership Project (3GPP) specification defines three types of HARQ-ACK codebooks including (1) a type I HARQ-ACK codebook (simply referred to herein as “type I” or “type 1”), (2) a type II HARQ-ACK codebook (simply referred to herein as “type II” or “type 2”), and (3) a type III HARQ-ACK codebook (simply referred to herein as “type III” or “type 3”). HARQ-ACK codebook types I, II, and III may differentiate based on their dynamic nature, with type I being a static codebook, type II being dynamic and adapting to a number of downlink (e.g., PDSCH) transmissions requiring feedback, and type 3 being a “one-shot” codebook used for situations where only a single feedback is needed, generally resulting in lower overhead but potentially less flexibility.

A HARQ-ACK codebook may include a collection of codewords, where each codeword is a sequence of coded bits that represents an encoded version of a message, data, or communication conveying HARQ-ACK feedback. For example, HARQ-ACK feedback for multiple downlink data messages may be represented as multiple information bits (e.g., also referred to as “data bits” or “HARQ bits”). For example, a first information bit may represent ACK/NACK feedback for a first downlink data message, a second information bit may represent ACK/NACK feedback for a second downlink data message, etc. The information bits representing the HARQ-ACK feedback may be encoded, with or without parity bits (e.g., redundant bits, which are designed to help detect or correct errors during transmission), into a set of coded bits, thereby creating a “codeword.” A HARQ-ACK codebook may include multiple codewords comprising multiple sequences of coded bits, which represent different ACK/NACK feedback sequences (e.g., for one or more data packets, such as one or more downlink data messages), or “HARQ bit payloads,” that may be used when signaling HARQ-ACK feedback to a transmitter (e.g., a network entity).

A size of a codebook, or a number of codewords included in a codebook, may be equal to a base-2 exponential of a parameter k, where the parameter k represents a number of information bits (or HARQ bits) per codeword. Put differently, a number of codewords in a codebook may include 2^{k} codewords, with cₘ denoting the m-th codeword in the codebook, where m=[0, 1, 2, . . . , (2^{k}−1)]. For example, for k=11, a codebook may include 2^{k}=2,048 codewords. Further, the codebook may be associated with a parameter n, which specifies the length, or more specifically, a number of coded bits in each codeword cₘ included in the codebook (e.g., a codeword cₘ is a length-n vector).

With respect to a downlink data channel, such as the PDSCH, a typical target block error rate (BLER) (e.g., a ratio of erroneous transport blocks (TBs) received to the total number TBs transmitted) may be around 10%, meaning a receiver, e.g., a UE, may be expected to receive at least 90% of the data messages sent (e.g., as data packets or TBs) to the UE via the PDSCH. The 10% target BLER may be one example target metric for PDSCH performance, aiming to help strike a balance between reliable data transmission and efficient resource utilization. If the target BLER for the PDSCH is 10%, then a probability that HARQ-ACK feedback comprises ACK feedback for a data message sent to the UE may be equal to 90% (e.g., P (ACK)=90% for one data message). As a result, when utilizing a codebook to signal HARQ-ACK feedback for downlink data messages sent via the PDSCH, codewords in the codebook associated with ACK feedback in most of the HARQ bits may be more likely to be used by the UE than codewords associated with NACK feedback in most of the HARQ bits. For example, with respect to a 10% target BLER, a UE may be more likely to transmit a first codeword including coded bits corresponding to information bits representing ACK feedback for all downlink data messages, than a second codeword including coded bits corresponding to information bits representing NACK feedback for all downlink data messages (e.g., probability of transmitting the first codeword>probability of transmitting the second codeword).

Technical problems associated with the use of existing HARQ-ACK codebooks, including, for example, the type I, type II, and/or type III HARQ-ACK codebooks defined by 3GPP (e.g., as described above), involve their failure to exploit such non-uniform probabilistic distribution of HARQ bit payloads in different scenarios. For example, existing HARQ-ACK codebooks may be designed with a uniform probability distribution, such that it is assumed that each codeword in the codebook has the same probability of being selected for transmission (e.g., when signaling HARQ-ACK feedback). As an illustrative example, a codebook may be designed to include four codewords, where each codeword corresponds to different HARQ-ACK feedback for two HARQ bits, and further each codeword is assumed to have an equal 25% chance of being selected for transmission, even though one codeword may be likely to be transmitted more often than the other codewords. While in some cases assuming equal probability of transmission among codewords in a codebook may be warranted, in some other cases, this assumption may lead to the suboptimal design of codewords and thus result in suboptimal HARQ performance. Specifically, the inability of the codebook to exploit the source distribution of the HARQ bit payloads, such as based on different levels of correlation ρ among HARQ bits and/or different target metrics (e.g., different BLER targets), may in some cases, result in the design of codewords that are less effective for reliable reception and decoding by a network entity.

For example, a codebook designed to assume equal probability of transmission among codewords (e.g., a codebook not well suited to optimally exploit current HARQ bit payload distribution) may result, in some cases, in the design of more frequent codewords (e.g., associated with the codebook) having smaller pair-wise distances between them, meaning that these more frequent codewords are close or similar, such as in terms of bit flips. Smaller pair-wise distances between more frequent codewords may increase the probability of decoding errors and the misinterpretation of such codewords by a network entity receiving these codewords when transmitted. As such, when conveying HARQ-ACK feedback using this codebook, the likelihood of decoding failures occurring and/or the need for additional re-transmissions may be increased, thereby adversely impacting overall system efficiency and HARQ performance. Further, in some cases to mitigate the likelihood of such decoding errors occurring, the minimum signal-to-noise ratio (SNR) required during communications using this codebook may be increased. Achieving this increased SNR during communications may be a technically challenging task, at least due to the inherent presence of noise in the wireless communications network. Accordingly, different codebooks adapted for different HARQ payload distribution, which exploit the varying probabilities associated with different codewords, may be desired.

Certain aspects described herein overcome the aforementioned technical problems associated with the use of existing HARQ-ACK codebooks and provide a technical benefit to the field of telecommunications. For example, certain aspects provide techniques for designing a codebook that is optimized for sending HARQ-ACK feedback associated with data communicated via a given channel. The codebook may exploit the non-uniform probability distribution of different HARQ bit payloads (and hence, the corresponding codewords) for the data communicated via the channel by optimizing more frequent codewords. For example, in certain aspects, the codebook may be designed such that the pair-wise distances between more frequent codewords are made larger in the codebook. The increased pair-wise distances between more frequent codewords may generally help to reduce decoding errors for such codewords when transmitted, as well as allow for the reduction (or minimization of) the required SNR.

Instead of designing the codebook from scratch, certain aspects described herein propose to fine-tune an existing codebook (e.g., also referred to herein as a “classical codebook,” which may include an existing codebook, such as one of the codebooks defined by 3GPP) using supervised learning techniques (e.g., such as in order to adjust the existing codebook to exploit the probably distribution of HARQ bit payload. For example, as described above, a classical codebook may include a collection of codewords, where a number of codewords included in the codebook may be based on a parameter k. To “fine-tune” the codebook, a binary phase shift keying (BPSK) symbol vector (e.g., xₘ) associated with each respective codeword (e.g., cₘ for an m^{th} codeword) (e.g., generated by modulating the respective codeword according to a BPSK modulation scheme) among one or more codewords in the codebook (e.g., all codewords or less than all codewords), may be perturbed with a perturbation vector (e.g., qₘ) associated with the respective codeword. Perturbing a BPSK symbol vector, associated with the respective codeword, with a perturbation vector may adjust the BPSK symbol vector (e.g., xₘ) associated with the respective codeword. As such, in certain aspects, HARQ-ACK feedback, formatted according to the codebook, may be sent as a carrier signal that is modulated based on a codeword cₘ in the codebook and a perturbation vector qₘ associated with the codeword.

In certain aspects, a perturbation vector, associated with a codeword (and applied to its corresponding BPSK symbol vector), may be learned during supervised machine learning (ML). For example, a gradient-based optimization method (e.g., backpropagation) used in the training of a neural network may be used to learn a perturbation vector for the codeword. In certain aspects, larger perturbation vectors may be learned for more frequent codewords in the codebook (e.g., higher probability codewords), while smaller perturbation vectors may be learned for less frequent codewords in the codebook (e.g., lower probability codewords).

In certain aspects, the codebook may be defined, such as in wireless communication standards (e.g., including the 3GPP specification), as a plurality of codewords

$${\{ {c}_{m} \}}_{m = 0}^{{2}^{k} - 1}$$

and a plurality of perturbation vectors

$${\{ {q}_{m} \}}_{m = 0}^{{2}^{k} - 1} .$$

In certain aspects, a receiver of data messages, such as a UE, may be instructed to generate HARQ-ACK feedback, for the data messages, that is formatted according to a fine-tuned codebook. In such cases, the receiver may receive an indication of the codewords and the perturbation vectors that together define the codebook and use this indicated information to generate HARQ-ACK feedback for the data messages. In certain aspects, the number of perturbation vectors qₘ defined for a codebook (and corresponding to codewords cₘ in the codebook) may be less than the size of the codebook. For example, in certain aspects, only a subset of the perturbation vectors qₘ learned for the codewords cₘ of the codebook may be specified for the codebook. The subset of perturbation vectors specified for the codebook may generally include the larger perturbation vectors qₘ.

Certain techniques described herein for generating HARQ-ACK feedback formatted according to a fine-tuned codebook may provide various beneficial technical effects and/or advantages. For example, these techniques may enable improved wireless communications performance, such as improved HARQ performance, reduction in the required SNR, efficient codebook design, and reduced complexity. The improved HAR Q performance and the reduction in the minimum SNR may be attributable to the use of fine-tuned codebooks that are designed to exploit the non-uniform probability distribution of different HARQ bit payloads (e.g., for different ranges of HARQ bit correlation values and/or target BLER metrics in different scenarios). The efficient codebook design may be attributable to the application of fine-tuning techniques to existing codebooks (e.g., classical codebooks), rather than generating such fine-tuned codebooks from scratch (e.g., thereby also saving resources). Further, the reduced complexity may be attributable to specification of less than all perturbation vectors for some codebooks. As such, in some cases when generating HARQ-ACK feedback, a carrier signal may be modulated according to only a codeword associated with the codebook and not both a codeword and its associated perturbation vector.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

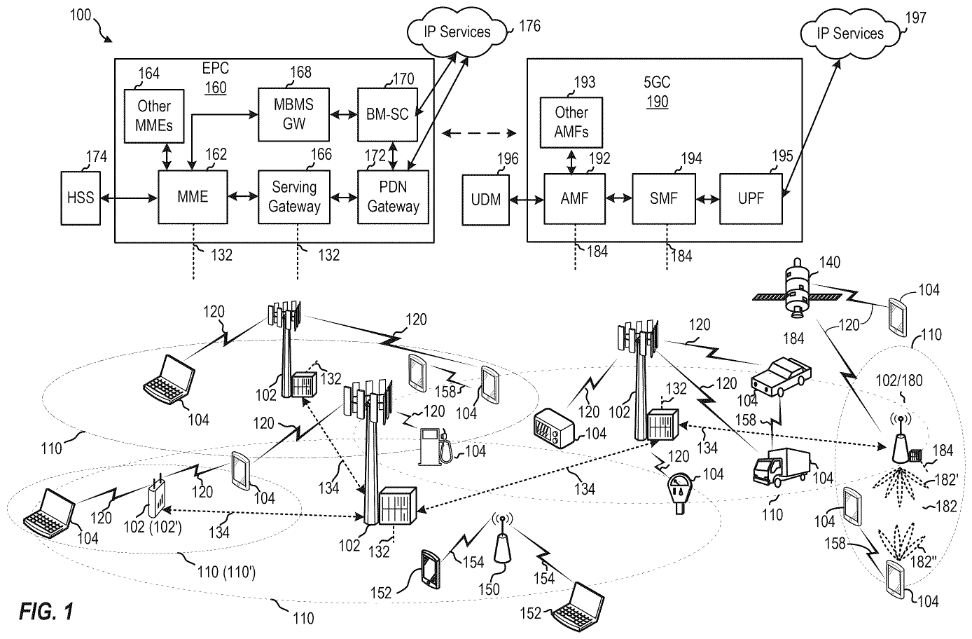

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IOT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gN B or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

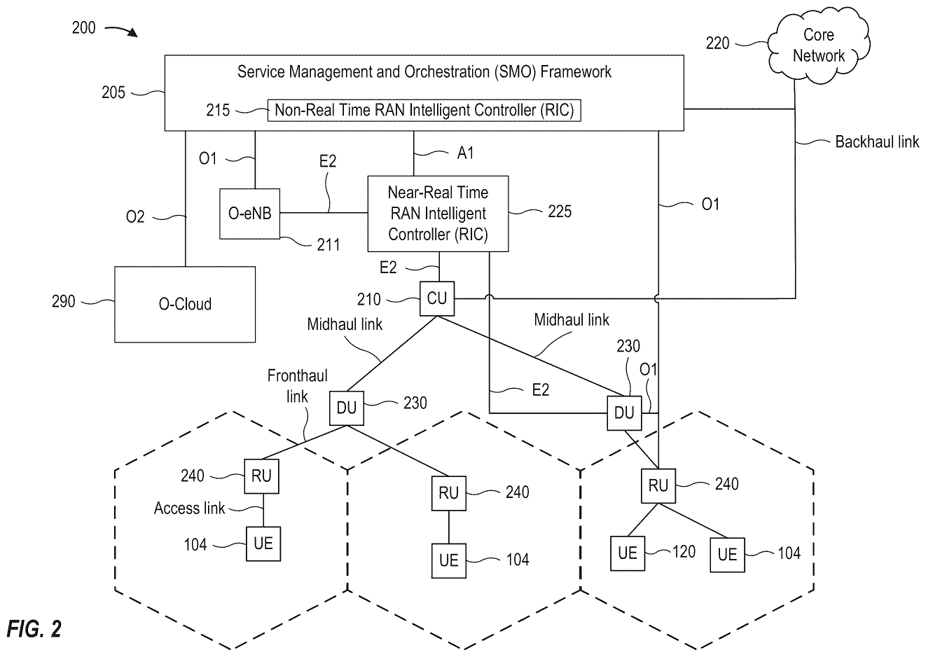

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR 2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eM BMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IM S, a PS streaming service, and/or other IP services.

In various aspects, a network entity or network node can be implemented as an aggregated base station, as a disaggregated base station, a component of a base station, an integrated access and backhaul (IA B) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the Cus 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

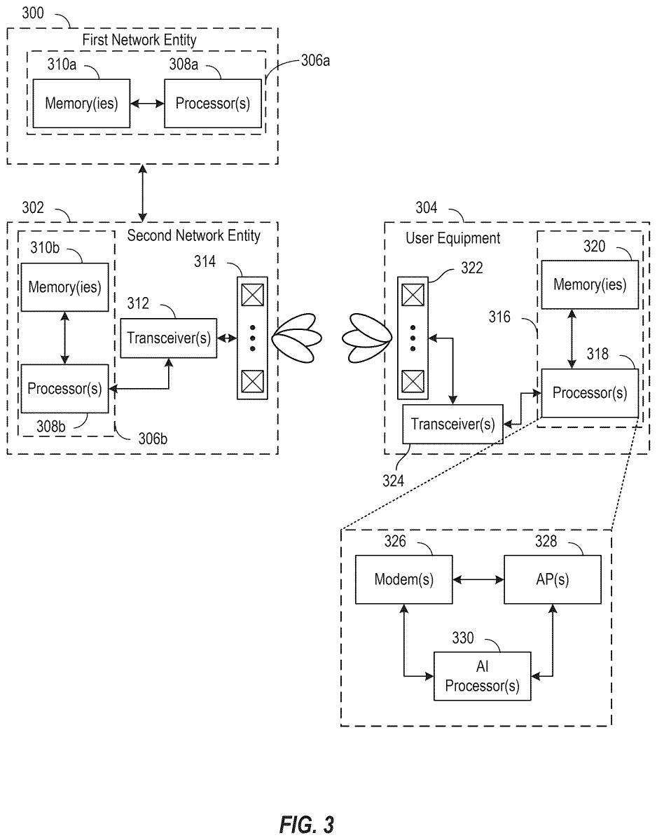

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGA s), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

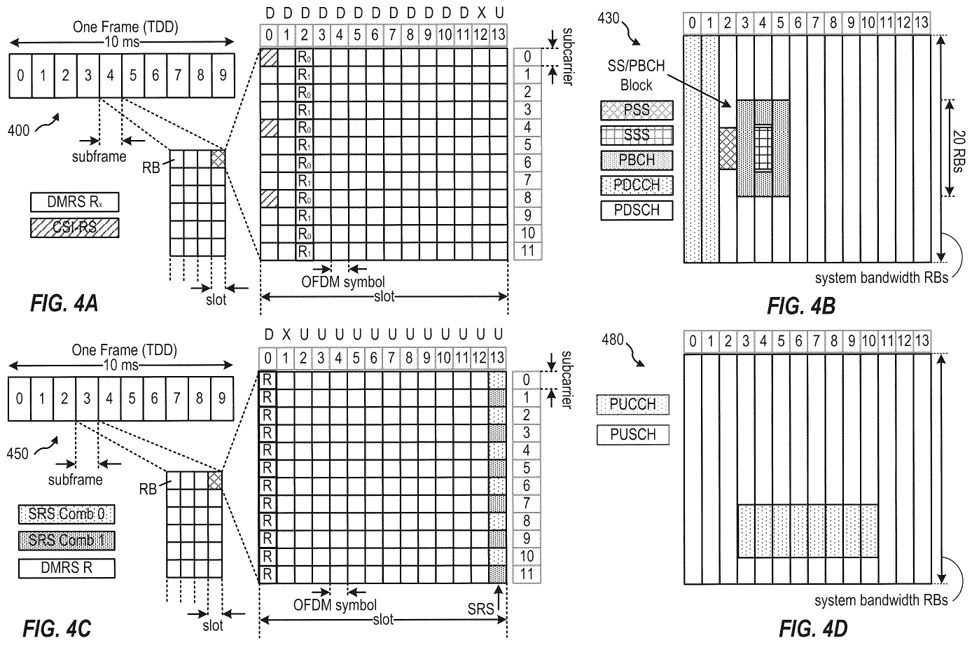

FIGS. 4A, 4B, 4C, and 4D depict aspects of data structures for a wireless communications network, such as wireless communications network 100 of FIG. 1

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 KHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PB CH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ-ACK/NACK feedback. The PUSCH carries data, and may additionally be used to carry a buffer status report (BSR), a power headroom report (PHR), and/or UCI.

### Example HARQ-ACK Codebooks

Wireless communications may be unreliable at times. Techniques, such as HARQ, may help to recover transmission errors by allowing an intended receiver of a transmitted data packet to indicate, to a transmitter of the transmitted data packet, whether the transmitted data packet was received and decoded successfully. As described herein, the receiver (1) may transmit an ACK when the receiver receives and is able to correctly decode the received data, and (2) may transmit a NACK when the receiver does not receive and/or is unable to correctly decode the data. A NACK may prompt the transmitter to re-transmit the data, with the hope that the re-transmitted data may be successfully received and correctly decoded at the receiver.

In some cases, a receiver may need to provide HARQ-ACK feedback (e.g., ACKs and/or NACKs) for multiple data packets at a same time (e.g., simultaneously). The receiver may transmit such HARQ-ACK feedback according to a HARQ-ACK codebook. Specifically, a HARQ-ACK codebook is a format for a sequence of bits to simultaneously signal multiple HARQ-ACKs and/or NACK s to a transmitter. A HARQ-ACK codebook may allow a receiver to multiplex HARQ-ACKs and/or NACKs from multiple slots, carriers, TBs, and/or code block groups (CBGs) within a single PUCCH or PUSCH transmission.

As described herein, the 3GPP specification defines three types of HARQ-ACK codebooks including (1) a type I HARQ-ACK codebook, (2) a type II HARQ-ACK codebook, and (3) a type III HARQ-ACK codebook.

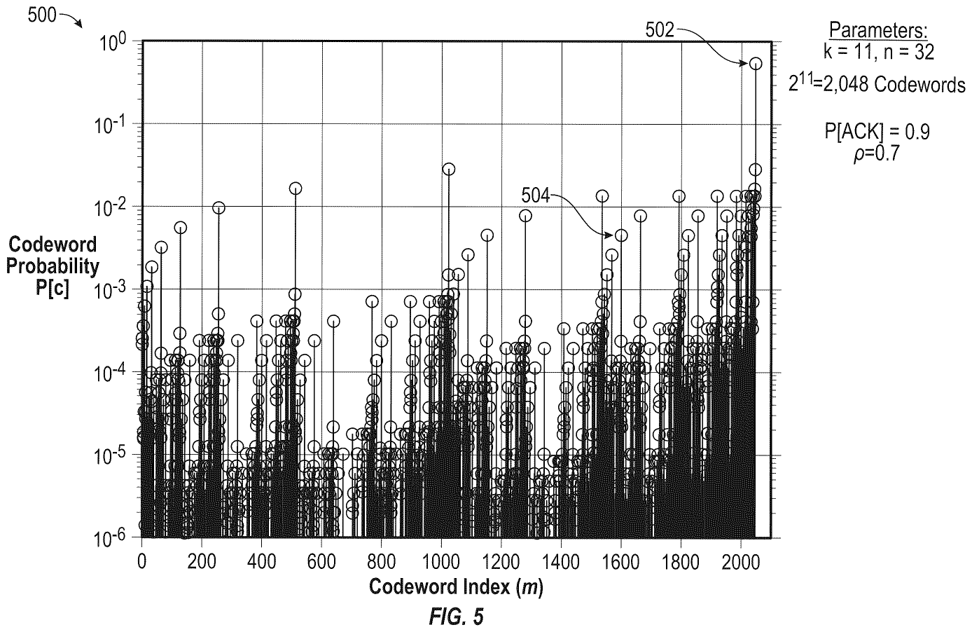

Classical HARQ-ACK codebooks, such as those defined in the 3GPP specification, may be designed with a uniform probability distribution, such that it is assumed that each codeword in the codebook has the same probability of being selected for transmission (e.g., when signaling HARQ-ACK feedback). However, in some cases, different codewords in the codebook may be associated with different probabilities. This means that some codewords may be more likely to occur or be selected for HARQ-ACK transmission than others. This non-uniform probability distribution among codewords is depicted in FIG. 5.

For example, as shown in FIG. 5, an example codebook may be associated with a parameter k=11 and a parameter n=32. Thus, the example codebook may include 2^{k}=211=2,048 codewords (e.g., 2,048 codewords cₘ where m=[0, 1, 2, . . . , 2,047]). Further, a number of coded bits in each codeword cₘ included in the codebook may be equal to n=32. For a target BLER=10%, a corresponding probability P (ACK)=0.9 (or 90%) for one data message, and a feedback bit correlation value (also referred to as a “HARQ bit correlation value”) ρ=0.7, the 2,048 codewords cₘ included in the codebook may have varying probability distributions, as shown in FIG. 5. For example, a codeword c₂₀₄₇ may have a codeword probability P [c₂₀₄₇]≈0.7 (e.g., as shown at 502), while a codeword c₌₁₆₀₀ may have a codeword probability P[c₁₆₀₀]≈0.003 (e.g., as shown at 504).

While in some cases assuming equal occurrence among codewords in a codebook may be warranted, in some other cases, this assumption may lead to the use of suboptimal codewords and thus result in suboptimal HARQ performance. As such, different codebooks adapted for different channel conditions, which exploit the varying probabilities associated with different codewords (e.g., in different scenarios and/or for different channel conditions) may be desired.

### Aspects Related to Providing HARQ-ACK Feedback Formatted According to a Fine-Tuned Codebook

Aspects described herein improve upon the state of the art by providing techniques for conveying HARQ-ACK feedback formatted according to a fine-tuned codebook. The fine-tuned codebook may be defined as multiple codewords and multiple perturbation vectors, where each codeword of a set of the codewords (e.g., all or less than all of the codewords) is associated with one of the perturbation vectors. Defining the codebook as the multiple codewords and the multiple perturbation vectors may allow for the exploitation of varying probabilities associated with different codewords in the codebook when generating HARQ-ACK feedback for data transmissions via different wireless communications channels and/or for different channel conditions. For example, in certain aspects, when generating and sending HARQ-ACK feedback for a data message, a carrier signal may be modulated based on a codeword in the codebook and a perturbation vector associated with the codeword.

In certain aspects, a receiver of data messages, such as a UE, may be instructed to generate HARQ-ACK feedback for the data messages, where the HARQ-ACK feedback is formatted according to a fine-tuned codebook. In such cases, the receiver may receive an indication of the codewords and the perturbation vectors that together define the codebook and use this indicated information to generate HARQ-ACK feedback for the data messages.

### Example Signaling for Conveying HARQ-ACK Feedback Formatted According to a Fine-Tuned Codebook

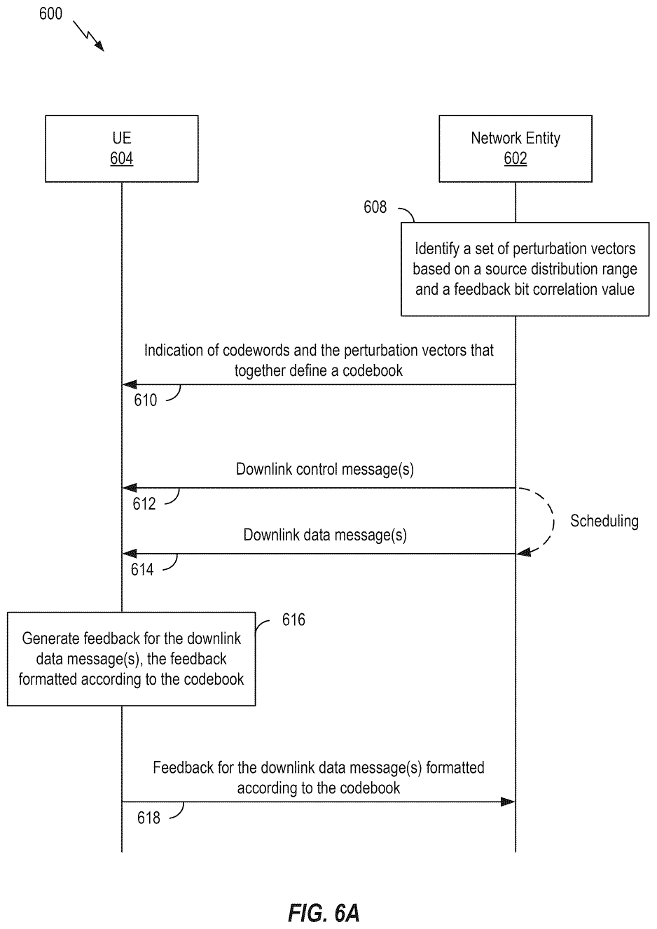

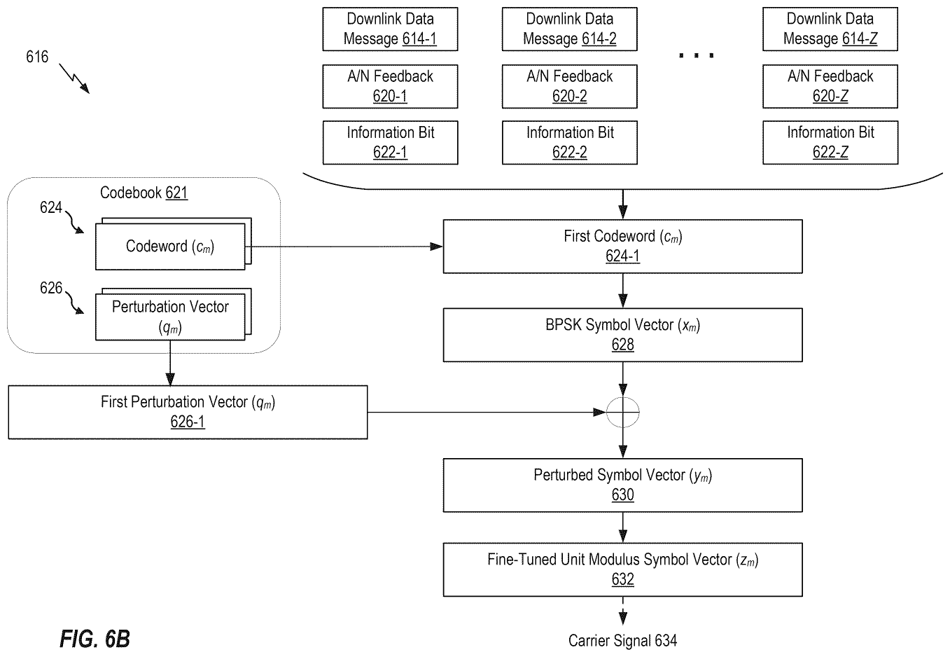

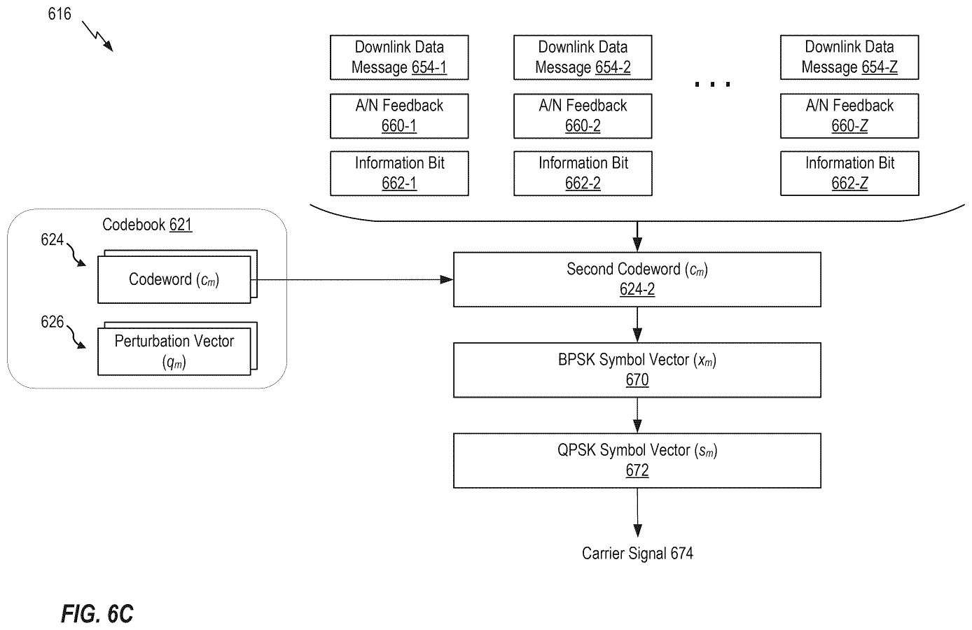

FIG. 6A depicts a process flow 600 for communications in a network between a network entity 602 and a UE 604. In certain aspects, the network entity 602 may be an example of the BS 102 depicted and described with respect to FIG. 1 the first network entity 300 or the second network entity 302 depicted and described with respect to FIG. 3, or a disaggregated base station depicted and described with respect to FIG. 2. Similarly, the UE 604 may be an example of UE 104 depicted and described with respect to FIG. 1 or the UE 304 depicted and described with respect to FIG. 3. However, in other aspects, UE 604 may be another type of wireless communications device and network entity 602 may be another type of network entity or network node, such as those described herein. Note that any operations or signaling illustrated with dashed lines may indicate that that operation or signaling is an optional or alternative example.

In certain aspects, communications between network entity 602 and UE 604 in process flow 600 may be used for generating and sending HARQ-ACK feedback formatted according to a fine-tuned codebook. For example, the fine-tuned codebook may be defined as a set of codewords and a set of perturbation vectors, where each codeword of a subset of the set of codewords (e.g., all or less than all of the codewords) is associated with one of the perturbation vectors.

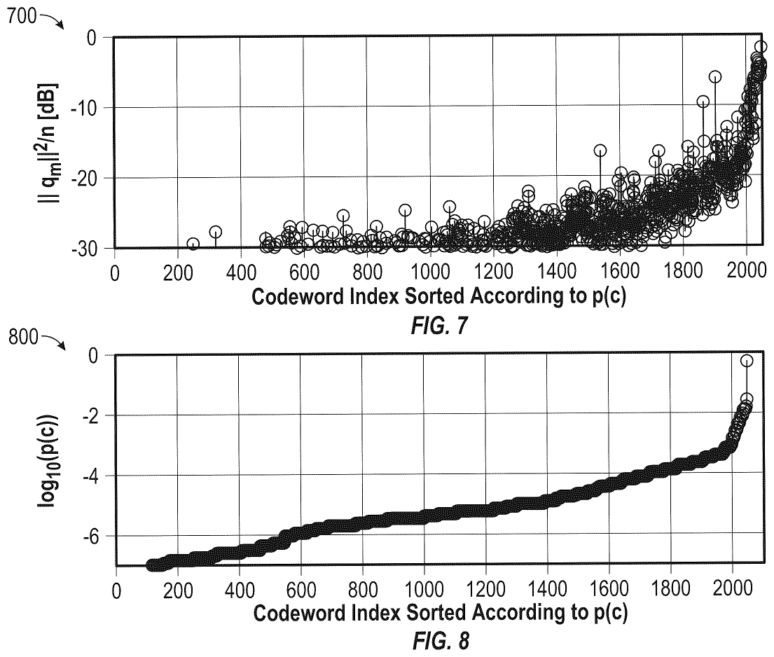

Process flow 600 begins, at 608, with network entity 602 identifying the set of perturbation vectors associated with the codebook. In certain aspects, the network entity 602 identifies the set of perturbation vectors based on a source distribution range (P (ACK)=[min probability, max probability]) indicating a range of probability values that an information bit of multiple information bits, or “HARQ bits” representing HARQ-ACK feedback, represents ACK feedback. In certain aspects, the network entity 602 identifies the set of perturbation vectors further based on a feedback bit correlation value range (ρ=[min feedback correlation value, max feedback correlation value]). That is, different sets of perturbation vectors may be learned for different (1) source distribution ranges and (2) feedback correlation values. Details related to learning perturbation vectors for these different variables are provided below with respect to FIGS. 7 and 8.

At 610, network entity 602 transmits, to UE 604, an indication of the codewords

$$( e . g . , {\{ {c}_{m} \}}_{m = 0}^{{2}^{k} - 1} )$$

and the identified perturbation vectors

$$( e . g . , {\{ {q}_{m} \}}_{m = 0}^{{2}^{k} - 1} )$$

that together define the codebook. A number of codewords associated with the codebook, and indicated to UE 604, may include 2^{k} codewords cₘ where m=[0, 1, 2, . . . , (2^{k}−1)]. Each codeword may comprise a sequence of coded bits, which represents an ACK/NACK feedback sequence (or “HARQ bit payload”), that may be provided as HARQ-ACK feedback for one or more data packets (e.g., such as one or more downlink data messages).

At 612, network entity 602 transmits, to UE 604, one or more downlink control messages (e.g. PDCCH(s) carrying DCI). Each downlink control message may schedule a downlink data message (e.g., a PDSCH). For example, in one example, network entity 602, may transmit, to UE 604, three downlink control messages that schedule three downlink data messages. The three downlink data messages may be scheduled such that they are sent to UE 604 during different time periods (e.g., in different slots, etc.).

At 614, network entity 602 transmits, to UE 604, the scheduled downlink data message(s).

At 616, UE 604 generates feedback for the downlink data message(s). The feedback may include HARQ-ACK feedback for the downlink data message(s), which may be formatted according to the codebook defined based on the indication at 610 (e.g., the codebook defined based on the indicated codewords and perturbation vectors).

In certain aspects, to generate the feedback at 616 according to the indicated codebook, UE 604 may modulate a carrier signal based on (1) a codeword, included in the codebook, that is associated with the feedback and (2) a perturbation vector associated with the codeword.

For example, as shown in FIG. 6B, downlink data messages 614-1 through 614-Z (collectively referred to herein as “downlink data messages 614” and individually referred to herein as “downlink data message 614”) may be scheduled via multiple downlink control messages at 612 in FIG. 6A. UE 604 may be configured to determine ACK/NACK (A/N) feedback 620-1 through 620-Z (collectively referred to herein as “A/N feedback 620” and individually referred to herein as “A/N feedback 620”) for the downlink data messages 614. More specifically, UE 604 may determine whether to generate ACK or NACK feedback (e.g., A/N feedback 620-1) for downlink data message 614-1, ACK or NACK feedback (e.g., A/N feedback 620-2) for downlink data message 614-2, and so on, up to downlink data message 614-Z. This A/N feedback 620 associated with the downlink data messages 614 may be represented as a plurality of information bits 622-1 through 622-Z (collectively referred to herein as “information bits 622” and individually referred to herein as “information bit 622”). For example, the A/N feedback 620-1 associated with downlink data message 614-1 may be represented as an information bit 622-1, the A/N feedback 620-2 associated with downlink data message 614-2 may be represented as information bit 622-2, . . . , and the A/N feedback 620-Z associated with downlink data message 614-Z may be represented as information bit 622-Z. Together the information bits 622 may represent the collective HARQ-ACK feedback for the downlink data messages 614.

To generate the HARQ-ACK feedback according to the indicated codebook, shown as codebook 621 in FIG. 6B, UE 604 may select a first codeword (cₘ) 624-1 among the plurality of codewords 624

$$( e . g . , {\{ {c}_{m} \}}_{m = 0}^{{2}^{k} - 1} )$$

where m=[0, 1, 2, . . . , (2^{k}−1)]) associated with the codebook 621 (e.g., indicated to UE 604 at 610 in FIG. 6A). The selected first codeword (cₘ) 624-1 may include a sequence of coded bits that represent the information bits 662. The selected first codeword (cₘ) 624-1 may be a length-n vector, such that cₘ(l)∈{0,1}, for l=0, 1, . . . , n−1 (e.g., where parameter n defines the number of coded bits of the first codeword (cₘ) 624-1).

UE 604 may modulate the sequence of coded bits, of the first codeword (cₘ) 624-1, according to a BPSK modulation scheme to generate a BPSK symbol vector (xₘ) 628. The BPSK symbol vector (xₘ) 628 may be a length-n vector, and xₘ(l)∈{−1,1}, for l=0, 1, . . . , n−1. In certain aspects, the BPSK symbol vector (xₘ) 628 may be generated based on the equation xₘ=1-2·cₘ, for m=[0, 1, 2, . . . , (2^{k}−1)].

UE 604 may then generate a perturbed symbol vector (yₘ) 630 based on both the BPSK symbol vector (xₘ) 628 and a first perturbation vector (qₘ) 626-1 among the plurality of perturbation vectors 626

$$( e . g . , {\{ {q}_{m} \}}_{m = 0}^{{2}^{k} - 1} where m = [ 0 , 1 , 2 , … , ( {2}^{k} - 1 ) ] ) ,$$

that is associated with the first codeword (cₘ) 624-1. In certain aspects, the first perturbation vector (qₘ) 626-1 may be added to the BPSK symbol vector (xₘ) 628 to generate the perturbed symbol vector (yₘ) 630. For example, yₘ=xₘ+qₘ, for m=[0, 1, 2, . . . , (2^{k}−1)].

UE 604 may convert the perturbed symbol vector (yₘ) 630 to a fine-tuned unit modulus symbol vector (zₘ) 632 comprising multiple symbols. Each symbol of the fine-tuned unit modulus symbol vector (zₘ) 632 may include a unit modulus (e.g., a complex number). The fine-tuned unit modulus symbol vector (zₘ) 632 may have a length n/2 and be given by the equation:

$${z}_{m} ( l ) = \frac{{y}_{m} ( 2 l ) + {jy}_{m} ( 2 l + 1 )}{\sqrt{{{y}_{m} ( 2 l )}^{2} + {{y}_{m} ( 2 l + 1 )}^{2}}}$$

for l=0, 1, . . . ,

$$\frac{n}{2} - 1$$

and [0, 1, 2, . . . , (2^{k}−1)]. Here, Zₘ(l) 632 may be a unit modulus symbol, i.e., |Zₘ(l)|=1. Further, zₘ(l) 632 may be transmitted on one of the resource elements of a PUCCH.

UE 604 may then generate a carrier signal 634 modulated based on the fine-tuned unit modulus symbol vector (zₘ) 632.

In certain other aspects, to generate the feedback at 616 in FIG. 6B, according to the indicated codebook, UE 604 may modulate a carrier signal based on only a codeword, included in the codebook, and not on both a codeword and a perturbation vector associated with the codeword. That is, the codeword used to modulate the carrier signal may be a codeword in the codebook that is not associated with any perturbation vector specified for the codebook. In other words, in some cases, less than all codewords in the codebook may be associated with perturbation vectors.

For example, as shown in FIG. 6C, downlink data messages 654-1 through 654-Z (collectively referred to herein as “downlink data messages 654” and individually referred to herein as “downlink data message 654”) may be scheduled via multiple downlink control messages at 612 in FIG. 6A. UE 604 may be configured to determine ACK/NACK (A/N) feedback 660-1 through 660-Z (collectively referred to herein as “A/N feedback 660” and individually referred to herein as “A/N feedback 660”) for the downlink data messages 654. More specifically, UE 604 may determine whether to generate ACK or NACK feedback (e.g., A/N feedback 660-1) for downlink data message 654-1, ACK or NACK feedback (e.g., A/N feedback 660-2) for downlink data message 654-2, and so on, up to downlink data message 654-Z. This A/N feedback 660 associated with the downlink data messages 654 may be represented as a plurality of information bits 662-1 through 662-Z (collectively referred to herein as “information bits 662” and individually referred to herein as “information bit 662”). For example, the A/N feedback 660-1 associated with downlink data message 654-1 may be represented as an information bit 662-1, the A/N feedback 660-2 associated with downlink data message 654-2 may be represented as information bit 662-2, . . . , and the A/N feedback 660-Z associated with downlink data message 654-Z may be represented as information bit 662-Z. Together the information bits 662 may represent the collective HARQ-ACK feedback for the downlink data messages 654.

To generate the HARQ-ACK feedback according to the indicated codebook, shown as codebook 621 in FIG. 6C, UE 604 may select a second codeword (cₘ) 624-2 among the plurality of codewords 624 (e.g., {cₘ}ₘ₌₀²^{^{k}}⁻¹ where m=[0, 1, 2, . . . , (2^{k}−1)]) associated with the codebook 621 (e.g., indicated to UE 604 at 610 in FIG. 6A). The second codeword (cₘ) 624-2 may include a sequence of coded bits that represent the information bits 662. The second codeword (cₘ) 624-2 may be a length-n vector, such that cₘ(l)∈{0,1}, for l=0, 1, . . . , n−1 (e.g., where parameter n defines the number of coded bits of the second codeword (cₘ) 624-2).

UE 604 may modulate the sequence of coded bits, of the second codeword (cₘ) 624-2, according to a BPSK modulation scheme to generate a BPSK symbol vector (xₘ) 670. The BPSK symbol vector (xₘ) 670 may be a length-n vector, and xₘ(l)∈{−1,1}, for l=0, 1, . . . , n−1. In certain aspects, the BPSK symbol vector (xₘ) 670 may be generated based on the equation xₘ=1-2·cₘ, for m=[0, 1, 2, . . . , (2^{k}−1)].

UE 604 may then convert the BPSK symbol vector (xₘ) 670 to a quadrature phase shift keying (QPSK) symbol vector (sₘ) 672 according to a QPSK modulation scheme. The QPSK symbol vector (sₘ) 672 may comprise multiple symbols. The QPSK symbol vector (sₘ) 672 may have a length n/2 and be given by the equation:

$${s}_{m} ( l ) = \frac{{x}_{m} ( 2 l ) + {jx}_{m} ( 2 l + 1 )}{\sqrt{{{x}_{m} ( 2 l )}^{2} + {{x}_{m} ( 2 l + 1 )}^{2}}} = \frac{{x}_{m} ( 2 l ) + {jx}_{m} ( 2 l + 1 )}{\sqrt{2}}$$

for l=0, 1, . . . ,

$$\frac{n}{2} - 1$$

and =[0, 1, 2, . . . , (2^{k}−1)]. Here, sₘ(l) 672 may be a unit modulus symbol, i.e., |sₘ(l)|=1. Further, sₘ(l) 672 may be transmitted on one of the resource elements of a PUCCH.

UE 604 may then generate a carrier signal 674 modulated based on the QPSK symbol vector (sₘ) 672.

As shown in FIG. 6C, unlike in FIG. 6B, because the second codeword (cₘ) 624-2 is not associated with any perturbation vector 626 in codebook 621, the BPSK symbol vector (xₘ) 670 may not be perturbed, and further a QPSK symbol vector (sₘ) 672 may be generated in place of a fine-tuned unit modulus symbol vector (zₘ) (e.g., such as fine-tuned unit modulus symbol vector (zₘ) 632 shown in FIG. 6B).

Returning to FIG. 6A, after generating the feedback, at 618, UE 604 transmits, to network entity 602, the feedback for the downlink data message(s) formatted according to the codebook. For example, UE 604 may transmit carrier signal 634 generated in FIG. 6B or carrier signal 674 generated in FIG. 6C.

In certain aspects, the perturbation vectors

$${\{ {q}_{m} \}}_{m = 0}^{{2}^{k} - 1}$$

associated with a fine-tuned codebook (e.g., such as codebook 621 in FIGS. 6B and 6C) may be learned via a gradient-based optimization method that is designed to optimize perturbation vectors based on (1) a source distribution range (P(ACK)=[min probability, max probability]) and (2) a feedback bit correlation value range (ρ=[min feedback correlation value, max feedback correlation value]). The source distribution range may indicate a range of probability values that an information bit of multiple information bits represents ACK feedback.

In certain aspects, the gradient-based optimization method may utilize a cross-entropy loss function based on a transmitted codeword, a vector of received resource elements (REs) corresponding to the transmitted codeword, and a set of perturbation vectors. For example, the cross-entropy loss function may be given by the ensemble average of the negative logarithm of a conditional probability, for example:

$$- {E}_{c , r} [ log p ( r \vert c , {\{ {q}_{m} \}}_{m = 0}^{{2}^{k} - 1} ) ]$$

where c represents the transmitted codeword, r represents the vector

$$( e . g . , of length \frac{n}{2} )$$

of received REs corresponding to the transmitted codeword

$$c , {\{ {q}_{m} \}}_{m = 0}^{{2}^{k} - 1}$$

represents the set of perturbation vectors for a parameter k value, and p represents the probability, as in the probability of observing r conditioned on codeword c and the set of perturbation vectors

$${\{ {q}_{m} \}}_{m = 0}^{{2}^{k} - 1} .$$

As an illustrative example, a set of perturbation vectors may be learned based on performing four steps. In a first step, a codeword c may be sampled according to a source distribution range (e.g., characterized by P (ACK)) and a feedback bit correlation value range (ρ). The sampled codeword c may comprise a codeword cₘ or the m^{th} codeword of a codebook.

In a second step, given the codeword cₘ and a set of perturbation vectors

$${\{ {q}_{m} \}}_{m = 0}^{{2}^{k} - 1} ,$$

a vector r (e.g., received by a network entity, such as network entity 602 in FIG. 6A) may be generated according to the probability distribution

$$p ( r \vert c = {c}_{m} , {\{ {q}_{m} \}}_{m = 0}^{{2}^{k} - 1} ) . Here , p ( r \vert c = {c}_{m} , {\{ {q}_{m} \}}_{m = 0}^{{2}^{k} - 1} )$$

may comprises a conditional Gaussian probability distribution; thus,

$$p ( r \vert c = {c}_{m} , {\{ {q}_{m} \}}_{m = 0}^{{2}^{k} - 1} )$$

may be computed mathematically.

In a third step, the cross-entropy loss given by

$$- {E}_{c , r} [ log p ( r \vert c , {\{ {q}_{m} \}}_{m = 0}^{{2}^{k} - 1} ) ]$$

may be computed. Specifically, because

$$p ( r \vert c = {c}_{m} , {\{ {q}_{m} \}}_{m = 0}^{{2}^{k} - 1} )$$

is able to be computed, the cross entropy loss given by

$$- {E}_{c , r} [ log p ( r \vert c , {\{ {q}_{m} \}}_{m = 0}^{{2}^{k} - 1} ) ]$$

may also be computed or approximated, such as using Monte Carlo integration.

In a fourth step, back-propagation on the computed cross-entropy loss may be used to update the set of perturbation vectors

$${\{ {q}_{m} \}}_{m = 0}^{{2}^{k} - 1} .$$

In certain aspects, steps one through four may be repeated until the set of perturbation vectors

$${\{ {q}_{m} \}}_{m = 0}^{{2}^{k} - 1}$$

converge.

FIG. 7 depicts example perturbation vectors that are learned for different codewords in a codebook. M ore specifically, FIG. 7 depicts example perturbation vectors

$${\{ {q}_{m} \}}_{m = 0}^{{2}^{k} - 1}$$

that are learned for a codebook defined by parameters k=11 (e.g., a codebook of 2,048 codewords) and n=32. Further, the perturbation vectors may be learned for a source distribution range of P(ACK)∈[0.8, 0.95] (e.g., a probability that an information bit includes ACK feedback 80% to 95% of the time) and a feedback bit correlation range of ρ∈[0,1]. The graph 700 shown in FIG. 7 illustrates a relationship between each codeword of the codebook (e.g., sorted along the x-axis of graph 700 according to its associated probability, p(c)) and its learned perturbation vector (e.g., associated with

$$\frac{{‖ {q}_{m} ‖}^{2}}{n}$$

in db scale along the y-axis of graph 700, where ∥qₘ∥ denotes the L 2 norm of qₘ, and ∥qₘ∥² represents the energy of qₘ).

FIG. 8 depicts example probabilities (e.g., p (c)) associated with the different codewords of the codebook referenced in FIG. 7 (e.g., for which perturbation vectors are learned). The probabilities of the different codewords may be based on a source distribution of P(ACK)=0.9 (e.g., a probability that an information bit includes ACK feedback 90% of the time) and a feedback bit correlation range of ρ=0.7. As shown in both FIG. 7 and FIG. 8, more frequent codewords (e.g., codewords associated with higher probabilities p(c)) may tend to have larger associated perturbation vectors (e.g., associated with larger

$$\frac{{‖ {q}_{m} ‖}^{2}}{n}$$

values).

In certain aspects, less than all perturbation vectors learned for a codebook may be specified for the codebook (e.g., such as specified in wireless communications standards). For example, in certain aspects, the energy of a perturbation vector qₘ (i.e. ∥qₘ∥²), may be sufficiently small; thus, it may be unnecessary to perturb a BPSK symbol vector xₘ generated for a codeword cₘ (e.g., as shown in FIG. 6B) without affecting the decoding performance at a network entity. In such a case, rather than specifying the perturbed vectors

$${\{ {q}_{m} \}}_{m = 0}^{{2}^{k} - 1}$$

learned for all codewords of the codebook, only a subset of those perturbed vectors may need to be specified for the codebook, along with the all the codewords

$${\{ {c}_{m} \}}_{m = 0}^{{2}^{k} - 1}$$

for the codebook. Put differently, in certain aspects, a number of perturbation vectors specified for a codebook may be less than a number of codewords associated with the codebook.

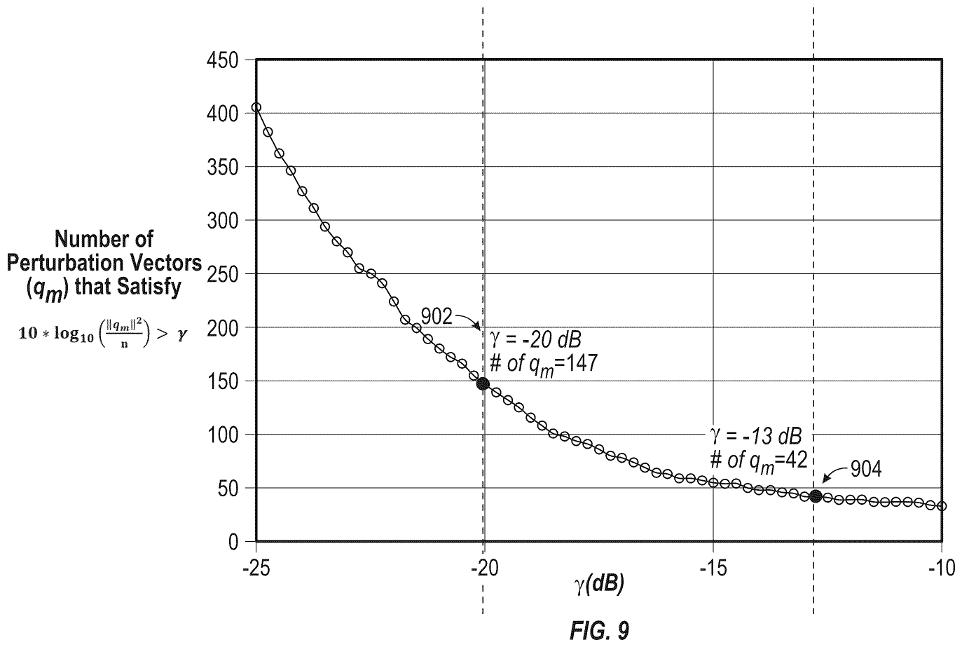

FIG. 9 depicts example pruning of perturbation vectors learned for a codebook such that less than all perturbation vectors learned for the codebook are specified for the codebook. For example, in a first case shown in FIG. 9, only perturbation vectors with an associated energy

$$10 * {log}_{10} ( \frac{{‖ {q}_{m} ‖}^{2}}{n} ) > γ = - 20 dB$$

may be specified for the codebook (e.g., 10*log₁₀(x)=x in dB). As such, in this example first case, only 147 learned perturbation vectors (e.g., less than all perturbation vectors associated with codewords of the codebook) may be specified for the codebook (e.g., as shown at 902). In a second case shown in FIG. 9, only perturbation vectors with an associated energy

$$10 * {log}_{10} ( \frac{{‖ {q}_{m} ‖}^{2}}{n} ) > γ = - 13 dB$$

may be specified for the codebook. As such, in this example second case, only 42 learned perturbation vectors may be specified for the codebook (e.g., as shown at 904).

### Example Operations of a User Equipment

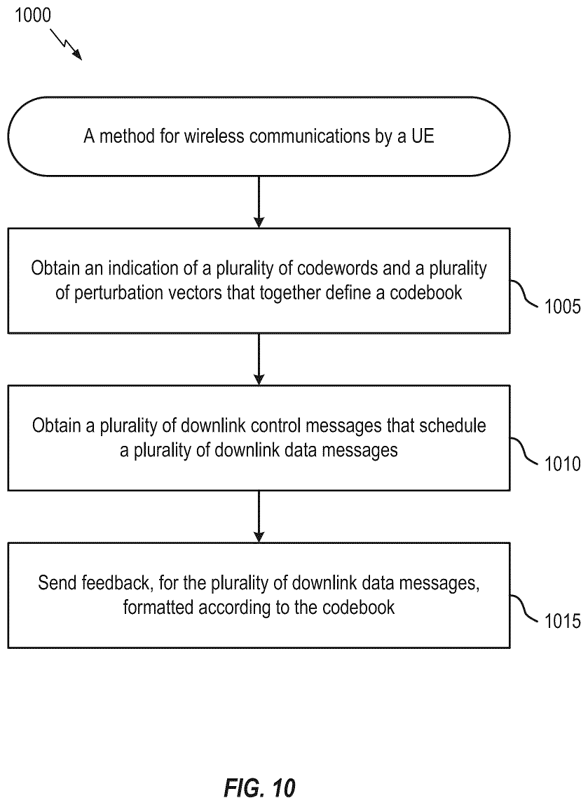

FIG. 10 shows a method 1000 for wireless communications by a UE, such as UE 104 of FIG. 10r UE 304 of FIG. 3.

Method 1000 begins at block 1005 with obtaining an indication of a plurality of codewords and a plurality of perturbation vectors that together define a codebook.

Method 1000 then proceeds to block 1010 with obtaining a plurality of downlink control messages that schedule a plurality of downlink data messages.

Method 1000 then proceeds to block 1015 with sending feedback, for the plurality of downlink data messages, formatted according to the codebook.

In some aspects, each perturbation vector of the plurality of perturbation vectors is associated with a respective codeword of the plurality of codewords.

In some aspects, a number of the plurality of perturbation vectors is less than a number of the plurality of codewords.

In some aspects, the number of the plurality of codewords is based on a number of information bits per codeword.

In some aspects, block 1015 includes sending a carrier signal modulated based on: a first codeword, of the plurality of codewords, associated with the feedback; and a first perturbation vector, of the plurality of perturbation vectors, associated with the first codeword.

In some aspects, the feedback is represented as a plurality of information bits associated with the plurality of downlink data messages; and block 1015 includes: selecting a first codeword among the plurality of codewords, the first codeword comprising a sequence of coded bits that represent the plurality of information bits; modulating the sequence of coded bits according to a BPSK modulation scheme to generate a BPSK symbol vector; generating a perturbed symbol vector based on the BPSK symbol vector and a first perturbation vector, of the plurality of perturbation vectors, associated with the first codeword; converting the perturbed symbol vector to a fine-tuned unit modulus symbol vector comprising a plurality of symbols, each symbol comprising a unit modulus; and sending a carrier signal modulated based on the fine-tuned unit modulus symbol vector.

In some aspects, generating the perturbed symbol vector comprises adding the first perturbation vector to the BPSK symbol vector.

In some aspects, each codeword in a first subset of the plurality of codewords is associated with a respective perturbation vector of the plurality of perturbation vectors; each codeword in a second subset of the plurality of codewords is not associated with any perturbation vector, the second subset of the plurality of codewords comprising at least a first codeword; the feedback is represented as a plurality of information bits associated with the plurality of downlink data messages; and block 1015 includes: selecting a first codeword among the plurality of codewords, the first codeword comprising a sequence of coded bits that represent the plurality of information bits; modulating the sequence of coded bits according to a BPSK modulation scheme to generate a BPSK symbol vector; converting the BPSK symbol vector to a QPSK symbol vector according to a QPSK modulation scheme; and sending a carrier signal modulated based on the QPSK symbol vector.

In some aspects, the feedback is represented as a plurality of information bits associated with the plurality of downlink data messages; and the codebook is associated with: a source distribution range indicating a range of probability values that an information bit of the plurality of information bits represents ACK feedback; and a feedback bit correlation value range.

In some aspects, the feedback is represented as a plurality of information bits associated with the plurality of downlink data messages; and the plurality of perturbation vectors are learned via a gradient-based optimization method that is designed to optimize perturbation vectors based on: a source distribution range indicating a range of probability values that an information bit of the plurality of information bits represents ACK feedback; and a feedback bit correlation value range.

In some aspects, the gradient-based optimization method utilizes a cross-entropy loss function based on a transmitted codeword, a vector of received REs corresponding to the transmitted codeword, and a set of perturbation vectors.

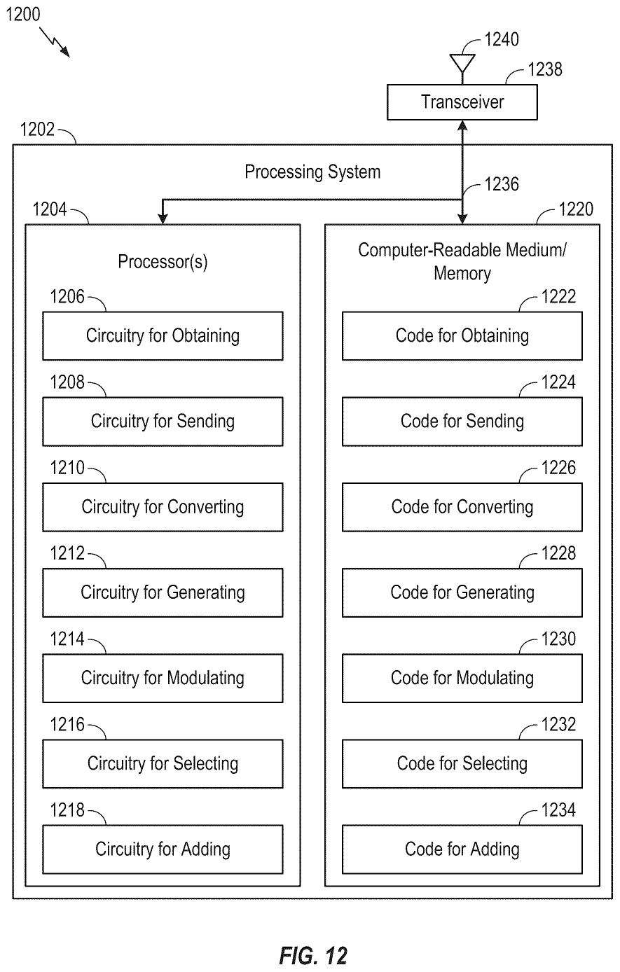

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Operations of a Network Entity

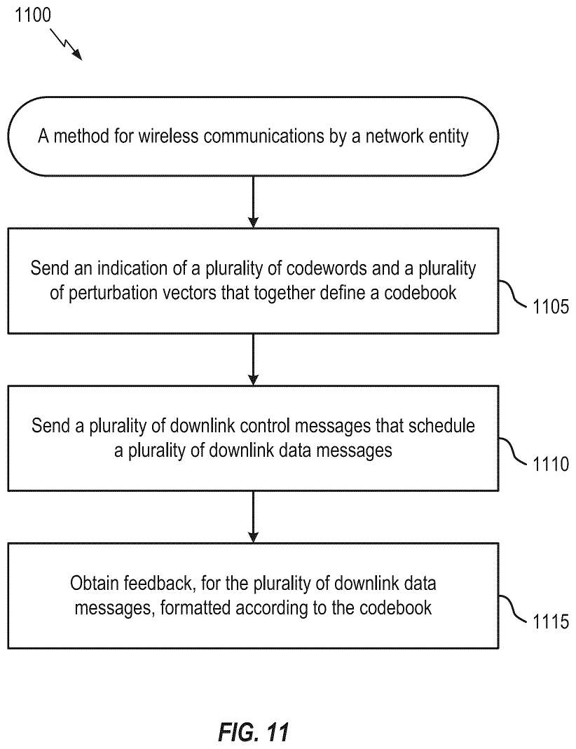

FIG. 11 shows a method 1100 for wireless communications by a network entity, such as BS 102 of FIG. 1 a first network entity 300 or second network entity 302 of FIG. 3, or a disaggregated base station as discussed with respect to FIG. 2.

Method 1100 begins at block 1105 with sending an indication of a plurality of codewords and a plurality of perturbation vectors that together define a codebook.

Method 1100 then proceeds to block 1110 with sending a plurality of downlink control messages that schedule a plurality of downlink data messages.

Method 1100 then proceeds to block 1115 with obtaining feedback, for the plurality of downlink data messages, formatted according to the codebook.

In some aspects, each perturbation vector of the plurality of perturbation vectors is associated with a respective codeword of the plurality of codewords.

In some aspects, a number of the plurality of perturbation vectors is less than a number of the plurality of codewords.

In some aspects, the number of the plurality of codewords is based on a number of information bits per codeword.

In some aspects, block 1115 includes obtaining a carrier signal modulated based on: a first codeword, of the plurality of codewords, associated with the feedback; and a first perturbation vector, of the plurality of perturbation vectors, associated with the first codeword.

In some aspects, the feedback is represented as a plurality of information bits associated with the plurality of downlink data messages; and the codebook is associated with: a source distribution range indicating a range of probability values that an information bit of the plurality of information bits represents ACK feedback; and a feedback bit correlation value range.

In some aspects, the feedback is represented as a plurality of information bits associated with the plurality of downlink data messages; and the plurality of perturbation vectors are learned via a gradient-based optimization method that is designed to optimize perturbation vectors based on: a source distribution range indicating a range of probability values that an information bit of the plurality of information bits represents ACK feedback; and a feedback bit correlation value range.

In some aspects, the gradient-based optimization method utilizes a cross-entropy loss function based on a transmitted codeword, a vector of received REs corresponding to the transmitted codeword, and a set of perturbation vectors.

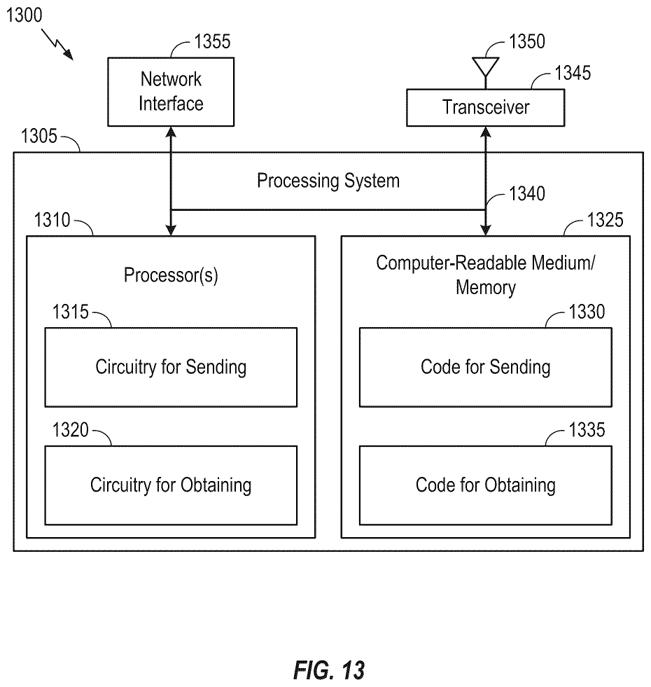

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200 configured for wireless communications. In some aspects, communications device 1200 is a user equipment, such as UE 104 described above with respect to FIG. 10r UE 304 described with respect to FIG. 3.

The communications device 1200 includes a processing system 1202 coupled to a transceiver 1238 (e.g., a transmitter and/or a receiver). The transceiver 1238 is configured to transmit and receive signals for the communications device 1200 via an antenna 1240, such as the various signals as described herein. The processing system 1202 may be configured to perform processing functions for the communications device 1200, including processing signals received and/or to be transmitted by the communications device 1200.

The processing system 1202 includes one or more processors 1204 and a computer-readable medium/memory 1220. In various aspects, the one or more processors 1204 may be representative of the one or more processors 318 described with respect to FIG. 3. The one or more processors 1204 are coupled to a computer-readable medium/memory 1220 via a bus 1236. In some aspects, the computer-readable medium/memory 1220 may be representative of the one or more memories 320 described with respect to FIG. 3. The computer-readable medium/memory 1220 is a non-transitory computer-readable medium/memory. In certain aspects, the computer-readable medium/memory 1220 is configured to store instructions (e.g., computer-executable code), that when executed by the one or more processors 1204, cause the one or more processors 1204 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1220 stores code (e.g., executable instructions), including code for obtaining 1222, code for sending 1224, code for converting 1226, code for generating 1228, code for modulating 1230, code for selecting 1232, and code for adding 1234. Processing of the code 1222-1234 may enable and cause the communications device 1200 to perform the method 1000 described with respect to FIG. 10, or any aspect related to it. For instance, in some aspects, code for obtaining 1222 includes code for obtaining an indication of a plurality of codewords and a plurality of perturbation vectors that together define a codebook. In some aspects, code for obtaining 1222 includes code for obtaining a plurality of downlink control messages that schedule a plurality of downlink data messages. In some aspects, code for sending 1224 includes code for sending feedback, for the plurality of downlink data messages, formatted according to the codebook.

The one or more processors 1204 include circuitry configured to implement (e.g., execute) the code stored in the computer-readable medium/memory 1220, including circuitry for obtaining 1206, circuitry for sending 1208, circuitry for converting 1210, circuitry for generating 1212, circuitry for modulating 1214, circuitry for selecting 1216, and circuitry for adding 1218. Processing with circuitry 1206-1218 may enable and cause the communications device 1200 to perform the method 1000 described with respect to FIG. 10, or any aspect related to it. For instance, in some aspects, circuitry for obtaining 1206 includes circuitry for obtaining an indication of a plurality of codewords and a plurality of perturbation vectors that together define a codebook. In some aspects, circuitry for obtaining 1206 includes circuitry for obtaining a plurality of downlink control messages that schedule a plurality of downlink data messages. In some aspects, circuitry for sending 1208 includes circuitry for sending feedback, for the plurality of downlink data messages, formatted according to the codebook.

More generally, means for communicating, transmitting, sending or outputting for transmission may include the one or more transceivers 324, one or more antenna 322 and/or processing system 316 of the UE 304 illustrated in FIG. 3, transceiver 1238 and/or antenna 1240 of the communications device 1200 in FIG. 12 and/or one or more processors 1204 of the communications device 1200 in FIG. 12. Means for communicating, receiving or obtaining may include the one or more transceivers 324, one or more antennas 322, and/or processing system 316 of the UE 304 illustrated in FIG. 3, transceiver 1238 and/or antenna 1240 of the communications device 1200 in FIG. 12 and/or one or more processors 1204 of the communications device 1200 in FIG. 12.

FIG. 13 depicts aspects of an example communications device configured for wireless communications. In some aspects, communications device 1300 is a network entity, such as BS 102 of FIG. 1, first network entity 300 or second network entity 302 of FIG. 3, or a disaggregated base station as discussed with respect to FIG. 2

The communications device 1300 includes a processing system 1305 coupled to a transceiver 1345 (e.g., a transmitter and/or a receiver) and/or a network interface 1355. The transceiver 1345 is configured to transmit and receive signals for the communications device 1300 via an antenna 1350, such as the various signals as described herein. The network interface 1355 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, one or more processors 1310 may be representative of the one or more processors 308, as described with respect to FIG. 3. The one or more processors 1310 are coupled to the computer-readable medium/memory 1325 via a bus 1340. In certain aspects, the computer-readable medium/memory 1325 is configured to store instructions (e.g., computer-executable code), including code for sending 1330 and code for obtaining 1335, that when executed by the one or more processors 1310, cause the one or more processors 1310 to perform the method 1100 described with respect to FIG. 11, or any aspect related to it, including any operations described in relation to FIG. 11. The computer-readable medium/memory 1325 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1325 stores code (e.g., executable instructions), including code for sending 1330 and code for obtaining 1335. Processing of the code for sending 1330 and code for obtaining 1335 may enable and cause the communications device 1300 to perform the method 1100 described with respect to FIG. 11, or any aspect related to it. For instance, in some aspects, code for sending 1330 includes code for sending an indication of a plurality of codewords and a plurality of perturbation vectors that together define a codebook. In some aspects, code for sending 1330 includes code for sending a plurality of downlink control messages that schedule a plurality of downlink data messages. In some aspects, code for obtaining 1335 includes code for obtaining feedback, for the plurality of downlink data messages, formatted according to the codebook.

The one or more processors 1310 include circuitry configured to implement (e.g., execute) the code stored in the computer-readable medium/memory 1325, including circuitry for sending 1315 and circuitry for obtaining 1320. Processing with circuitry for sending 1315 and circuitry for obtaining 1320 may enable and cause the communications device 1300 to perform the method 1100 described with respect to FIG. 11, or any aspect related to it. For instance, in some aspects, circuitry for sending 1315 includes circuitry for sending an indication of a plurality of codewords and a plurality of perturbation vectors that together define a codebook. In some aspects, circuitry for sending 1315 includes circuitry for sending a plurality of downlink control messages that schedule a plurality of downlink data messages. In some aspects, circuitry for obtaining 1320 includes circuitry for obtaining feedback, for the plurality of downlink data messages, formatted according to the codebook.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1345, antenna 1350, and/or network interface 1355 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1345, antenna 1350, and/or network interface 1355 of the communications device 1300 in FIG. 13, and/or one or more processors 1310 of the communications device 1300 in FIG. 13.

### Example Clauses

Implementation examples are described in the following numbered clauses:

Clause 1: A method for wireless communications by a UE comprising: obtaining an indication of a plurality of codewords and a plurality of perturbation vectors that together define a codebook; obtaining a plurality of downlink control messages that schedule a plurality of downlink data messages; and sending feedback, for the plurality of downlink data messages, formatted according to the codebook.

Clause 2: The method of Clause 1, wherein: each perturbation vector of the plurality of perturbation vectors is associated with a respective codeword of the plurality of codewords.

Clause 3: The method of any one of Clauses 1-2, wherein: a number of the plurality of perturbation vectors is less than a number of the plurality of codewords.

Clause 4: The method of Clause 3, wherein the number of the plurality of codewords is based on a number of information bits per codeword.

Clause 5: The method of any one of Clauses 1-4, wherein sending the feedback comprises sending a carrier signal modulated based on: a first codeword, of the plurality of codewords, associated with the feedback; and a first perturbation vector, of the plurality of perturbation vectors, associated with the first codeword.

Clause 6: The method of any one of Clauses 1-5, wherein: the feedback is represented as a plurality of information bits associated with the plurality of downlink data messages; and sending the feedback comprises: selecting a first codeword among the plurality of codewords, the first codeword comprising a sequence of coded bits that represent the plurality of information bits; modulating the sequence of coded bits according to a BPSK modulation scheme to generate a BPSK symbol vector; generating a perturbed symbol vector based on the BPSK symbol vector and a first perturbation vector, of the plurality of perturbation vectors, associated with the first codeword; converting the perturbed symbol vector to a fine-tuned unit modulus symbol vector comprising a plurality of symbols, each symbol comprising a unit modulus; and sending a carrier signal modulated based on the fine-tuned unit modulus symbol vector.

Clause 7: The method of Clause 6, wherein generating the perturbed symbol vector comprises adding the first perturbation vector to the BPSK symbol vector.

Clause 8: The method of any one of Clauses 1-7, wherein: each codeword in a first subset of the plurality of codewords is associated with a respective perturbation vector of the plurality of perturbation vectors; each codeword in a second subset of the plurality of codewords is not associated with any perturbation vector, the second subset of the plurality of codewords comprising at least a first codeword; the feedback is represented as a plurality of information bits associated with the plurality of downlink data messages; and sending the feedback comprises: selecting a first codeword among the plurality of codewords, the first codeword comprising a sequence of coded bits that represent the plurality of information bits; modulating the sequence of coded bits according to a BPSK modulation scheme to generate a BPSK symbol vector; converting the BPSK symbol vector to a QPSK symbol vector according to a QPSK modulation scheme; and sending a carrier signal modulated based on the QPSK symbol vector.

Clause 9: The method of any one of Clauses 1-8, wherein: the feedback is represented as a plurality of information bits associated with the plurality of downlink data messages; and the codebook is associated with: a source distribution range indicating a range of probability values that an information bit of the plurality of information bits represents ACK feedback; and a feedback bit correlation value range.

Clause 10: The method of any one of Clauses 1-9, wherein: the feedback is represented as a plurality of information bits associated with the plurality of downlink data messages; and the plurality of perturbation vectors are learned via a gradient-based optimization method that is designed to optimize perturbation vectors based on: a source distribution range indicating a range of probability values that an information bit of the plurality of information bits represents ACK feedback; and a feedback bit correlation value range.

Clause 11: The method of Clause 10, wherein the gradient-based optimization method utilizes a cross-entropy loss function based on a transmitted codeword, a vector of received REs corresponding to the transmitted codeword, and a set of perturbation vectors.

Clause 12: A method for wireless communications by a network entity comprising: sending an indication of a plurality of codewords and a plurality of perturbation vectors that together define a codebook; sending a plurality of downlink control messages that schedule a plurality of downlink data messages; and obtaining feedback, for the plurality of downlink data messages, formatted according to the codebook.

Clause 13: The method of Clause 12, wherein: each perturbation vector of the plurality of perturbation vectors is associated with a respective codeword of the plurality of codewords.

Clause 14: The method of any one of Clauses 12-13, wherein: a number of the plurality of perturbation vectors is less than a number of the plurality of codewords.

Clause 15: The method of Clause 14, wherein the number of the plurality of codewords is based on a number of information bits per codeword.

Clause 16: The method of any one of Clauses 12-15, wherein obtaining the feedback comprises obtaining a carrier signal modulated based on: a first codeword, of the plurality of codewords, associated with the feedback; and a first perturbation vector, of the plurality of perturbation vectors, associated with the first codeword.

Clause 17: The method of any one of Clauses 12-16, wherein: the feedback is represented as a plurality of information bits associated with the plurality of downlink data messages; and the codebook is associated with: a source distribution range indicating a range of probability values that an information bit of the plurality of information bits represents ACK feedback; and a feedback bit correlation value range.

Clause 18: The method of any one of Clauses 12-17, wherein: the feedback is represented as a plurality of information bits associated with the plurality of downlink data messages; and the plurality of perturbation vectors are learned via a gradient-based optimization method that is designed to optimize perturbation vectors based on: a source distribution range indicating a range of probability values that an information bit of the plurality of information bits represents ACK feedback; and a feedback bit correlation value range.

Clause 19: The method of Clause 18, wherein the gradient-based optimization method utilizes a cross-entropy loss function based on a transmitted codeword, a vector of received REs corresponding to the transmitted codeword, and a set of perturbation vectors.

Clause 20: One or more apparatuses, comprising: one or more memories comprising executable instructions; and one or more processors configured to execute the executable instructions and cause the one or more apparatuses to perform a method in accordance with any one of Clauses 1-19.

Clause 21: One or more apparatuses configured for wireless communications, comprising: one or more memories; and one or more processors, coupled to the one or more memories, configured to cause the one or more apparatuses to perform a method in accordance with any one of Clauses 1-19.

Clause 22: One or more apparatuses configured for wireless communications, comprising: one or more memories; and one or more processors, coupled to the one or more memories, configured to perform a method in accordance with any one of Clauses 1-19.

Clause 23: One or more apparatuses, comprising means for performing a method in accordance with any one of Clauses 1-19.

Clause 24: One or more non-transitory computer-readable media comprising executable instructions that, when executed by one or more processors of one or more apparatuses, cause the one or more apparatuses to perform a method in accordance with any one of Clauses 1-19.

Clause 25: One or more computer program products embodied on one or more computer-readable storage media comprising code for performing a method in accordance with any one of Clauses 1-19.

Clause 26: One or more apparatuses configured for wireless communications, comprising: a processing system that includes one or more processors and one or more memories coupled with the one or more processors, the processing system configured to cause the one or more apparatuses to perform a method in accordance with any one of Clauses 1-19.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an A SIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain an indication of a plurality of codewords and a plurality of perturbation vectors that together define a codebook;
obtain a plurality of downlink control messages that schedule a plurality of downlink data messages; and
send feedback, for the plurality of downlink data messages, formatted according to the codebook.

2. The apparatus of claim 1, wherein:
each perturbation vector of the plurality of perturbation vectors is associated with a respective codeword of the plurality of codewords.

3. The apparatus of claim 1, wherein:
a number of the plurality of perturbation vectors is less than a number of the plurality of codewords.

4. The apparatus of claim 3, wherein the number of the plurality of codewords is based on a number of information bits per codeword.

5. The apparatus of claim 1, wherein to cause the UE to send the feedback, the processing system is configured to cause the UE to send a carrier signal modulated based on:
a first codeword, of the plurality of codewords, associated with the feedback; and
a first perturbation vector, of the plurality of perturbation vectors, associated with the first codeword.

6. The apparatus of claim 1, wherein:
the feedback is represented as a plurality of information bits associated with the plurality of downlink data messages; and
to cause the UE to send the feedback, the processing system is configured to cause the UE to:
select a first codeword among the plurality of codewords, the first codeword comprising a sequence of coded bits that represent the plurality of information bits;
modulate the sequence of coded bits according to a binary phase shift keying (BPSK) modulation scheme to generate a BPSK symbol vector;
generate a perturbed symbol vector based on the BPSK symbol vector and a first perturbation vector, of the plurality of perturbation vectors, associated with the first codeword;
convert the perturbed symbol vector to a fine-tuned unit modulus symbol vector comprising a plurality of symbols, each symbol comprising a unit modulus; and
send a carrier signal modulated based on the fine-tuned unit modulus symbol vector.

7. The apparatus of claim 6, wherein to cause the UE to generate the perturbed symbol vector, the processing system is configured to cause the UE to add the first perturbation vector to the BPSK symbol vector.

8. The apparatus of claim 1, wherein:
each codeword in a first subset of the plurality of codewords is associated with a respective perturbation vector of the plurality of perturbation vectors;
each codeword in a second subset of the plurality of codewords is not associated with any perturbation vector, the second subset of the plurality of codewords comprising at least a first codeword;
the feedback is represented as a plurality of information bits associated with the plurality of downlink data messages; and
to cause the UE to send the feedback, the processing system is configured to cause the UE to:
select a first codeword among the plurality of codewords, the first codeword comprising a sequence of coded bits that represent the plurality of information bits;
modulate the sequence of coded bits according to a binary phase shift keying (BPSK) modulation scheme to generate a BPSK symbol vector;
convert the BPSK symbol vector to a quadrature phase shift keying (QPSK) symbol vector according to a QPSK modulation scheme; and
send a carrier signal modulated based on the QPSK symbol vector.

9. The apparatus of claim 1, wherein:
the feedback is represented as a plurality of information bits associated with the plurality of downlink data messages; and
the codebook is associated with:
a source distribution range indicating a range of probability values that an information bit of the plurality of information bits represents acknowledgement (ACK) feedback; and
a feedback bit correlation value range.

10. The apparatus of claim 1, wherein:
the feedback is represented as a plurality of information bits associated with the plurality of downlink data messages; and
the plurality of perturbation vectors are learned via a gradient-based optimization method that is designed to optimize perturbation vectors based on:
a source distribution range indicating a range of probability values that an information bit of the plurality of information bits represents acknowledgement (ACK) feedback; and
a feedback bit correlation value range.

11. The apparatus of claim 10, wherein the gradient-based optimization method utilizes a cross-entropy loss function based on a transmitted codeword, a vector of received resource elements (REs) corresponding to the transmitted codeword, and a set of perturbation vectors.

12. A method for wireless communications by a user equipment (UE) comprising:
obtaining an indication of a plurality of codewords and a plurality of perturbation vectors that together define a codebook;
obtaining a plurality of downlink control messages that schedule a plurality of downlink data messages; and
sending feedback, for the plurality of downlink data messages, formatted according to the codebook.

13. The method of claim 12, wherein:
each perturbation vector of the plurality of perturbation vectors is associated with a respective codeword of the plurality of codewords.

14. The method of claim 12, wherein:
a number of the plurality of perturbation vectors is less than a number of the plurality of codewords.

15. The method of claim 14, wherein the number of the plurality of codewords is based on a number of information bits per codeword.

16. The method of claim 12, wherein sending the feedback comprises sending a carrier signal modulated based on:
a first codeword, of the plurality of codewords, associated with the feedback; and
a first perturbation vector, of the plurality of perturbation vectors, associated with the first codeword.

17. The method of claim 12, wherein:
the feedback is represented as a plurality of information bits associated with the plurality of downlink data messages; and
sending the feedback comprises:
selecting a first codeword among the plurality of codewords, the first codeword comprising a sequence of coded bits that represent the plurality of information bits;
modulating the sequence of coded bits according to a binary phase shift keying (BPSK) modulation scheme to generate a BPSK symbol vector;
generating a perturbed symbol vector based on the BPSK symbol vector and a first perturbation vector, of the plurality of perturbation vectors, associated with the first codeword;
converting the perturbed symbol vector to a fine-tuned unit modulus symbol vector comprising a plurality of symbols, each symbol comprising a unit modulus; and
sending a carrier signal modulated based on the fine-tuned unit modulus symbol vector.

18. The method of claim 17, wherein generating the perturbed symbol vector comprises adding the first perturbation vector to the BPSK symbol vector.

19. The method of claim 12, wherein:
each codeword in a first subset of the plurality of codewords is associated with a respective perturbation vector of the plurality of perturbation vectors;
each codeword in a second subset of the plurality of codewords is not associated with any perturbation vector, the second subset of the plurality of codewords comprising at least a first codeword;
the feedback is represented as a plurality of information bits associated with the plurality of downlink data messages; and
sending the feedback comprises:
selecting a first codeword among the plurality of codewords, the first codeword comprising a sequence of coded bits that represent the plurality of information bits;
modulating the sequence of coded bits according to a binary phase shift keying (BPSK) modulation scheme to generate a BPSK symbol vector;
converting the BPSK symbol vector to a quadrature phase shift keying (QPSK) symbol vector according to a QPSK modulation scheme; and
sending a carrier signal modulated based on the QPSK symbol vector.

20. One or more non-transitory computer-readable media comprising executable instructions that, when executed by one or more processors of an apparatus, cause a user equipment (UE) to perform operations comprising:
obtaining an indication of a plurality of codewords and a plurality of perturbation vectors that together define a codebook;
obtaining a plurality of downlink control messages that schedule a plurality of downlink data messages; and
sending feedback, for the plurality of downlink data messages, formatted according to the codebook.
